(19) United States
(12) Patent Application Publication
(10) Pub. No.: US 2007/0118656 A1
(43) Pub. Date: May 24, 2007

(54) Inter-server multimodal network communications

(76) Inventors: David J. Anderson, Lawrenceville, GA (US); Michael S. Denny, Sharpsburg, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/283,076

(22) Filed: Nov. 18, 2005

(51) Int. Cl. G06F 15/16

(52) U.S. Cl. 709/227

(57) ABSTRACT

Included is a method for communicating session information to a first communications device, the session information being related to a communications that is established between a second communications device and a third communications device. Embodiments of the method include receiving session information related to the second communications device and storing at least a portion of the session information related to the second communications device. Embodiments of the method also include communicating at least a portion of the session information to the first communications device and resuming the communications session with the first device and the third device using at least a portion of the session information.

### CROSS REFERENCE

This application is related to copending U.S. Utility Patent Application entitled “Inter-Server Multimodal User Communications” filed on the same day as the present application and accorded Ser. No. ______, which is hereby incorporated by reference herein in its entirety.

### BACKGROUND

Today's emerging communications applications on a client device generally involve a network carrier's Time Division Multiplexing (TDM) or Internet Protocol (IP) connection and an entered telephone number or Universal Resource Locator (URL) to reach a network based hosted service. Generally, the user has access to many applications and many service providers. In particular, Internet access allows users to access applications hosted by different providers. However, when the user of the client device switches to another application, user context is typically lost and the new application is not aware of session information that could be advantageously used by the new application in support of the user. Loss of session context can also occur when the user accesses services from a different service provider. Session information from the prior service is lost when the new call is initiated or a URL is accessed.

With increasing technological capabilities and increased desire for communication services, consumers demand greater functionality from their communications services. More specifically, a user may begin a communications session in a voice-based protocol. The user may then determine midway through the communications session that video capabilities may be desired. The communications services today generally require the user to end the communications session and begin a new communications system with a device that supports both voice and video.

Similarly, a user may begin a cellular telephone call while he or she is driving home from work. When he or she arrives home, he or she is conscious of the extended use of the cellular telephone and may desire to change from the cell phone to a Public Switched Telephone Network (PSTN) telephone, or to an Internet Protocol (IP) network telephone. Currently, the user would end the current cellular telephone call, and begin another communications session from the PSTN or IP telephone.

Additionally, a first user (or server) may begin a telephone call with a second user (or server), and desire that the information from that telephone call be communicated to a third user (or server). As a nonlimiting example, a first user may make a telephone call to order movie tickets. The first user calls the movie theater (a second user) to purchase tickets for the 8:00 PM show. After the movie tickets are purchased, the first user then makes a call to a third user to make dinner reservations.

Currently, the restaurant will be unaware of the purchased movie tickets, and will therefore have no understanding of the desired time for the dinner reservations.

Thus, a heretofore unaddressed need exists in the industry to address the aforementioned deficiencies and inadequacies.

### SUMMARY

Included in this disclosure are systems and methods for communicating session information. At least one embodiment disclosed herein includes a method for communicating session information to a first communications device, the session information being related to a communications session that is established between a second communications device and a third communications device. Embodiments of the method include receiving session information related to the second communications device and storing at least a portion of the session information related to the second communications device. Embodiments of the method also include communicating at least a portion of the session information to the first communications device and resuming the communications session with the first device and the third device using at least a portion of the session information.

An additional nonlimiting example includes a method for maintaining session information while facilitating a mode change during a communications session between a first device and a second device. Embodiments of the method include receiving information related to the communications session; receiving mode change request from the first device; determining whether the second device supports the requested mode change; receiving a communication from the second device requesting at least a portion of the information related to the session; and facilitating the mode change while maintaining the communications session.

Additionally included in this disclosure is a computer readable medium configured to facilitate a device change from a first device to a second device, while maintaining a communications session with a third device. This nonlimiting example includes logic configured to receive information related to the communications session, logic configured to store at least a portion of the information related to the communications session, and logic configured to receive a communication from the first device requesting a device change. Also included in this nonlimiting example is logic configured to receive a communication from the second device requesting at least a portion of the information related to the session, and logic configured to communicate at least a portion of the information related to the communications session to the second communications device.

Other systems, methods, features and/or advantages will be or may become apparent to one with skill in the art upon examination of the following drawings and detailed description. It is intended that all such additional systems, methods, features and/or advantages be included within the scope of the present invention and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a functional diagram illustrating an embodiment of a communications network configuration.

FIG. 2 is a functional diagram illustrating a detailed view of a communications network configuration, similar to FIG. 1.

FIG. 3A is a functional diagram illustrating a first user changing devices during a communications session which may occur in a network configuration, such as the configuration from FIG. 1 or 2.

FIG. 3B is a functional diagram illustrating a second user changing devices during a communication session, which may occur in a network configuration, such as the configuration from FIG. 1 or 2.

FIG. 4 is a functional diagram illustrating a configuration of a multimodal protocol implemented with the network configuration from FIG. 2.

FIG. 5 is a functional diagram illustrating a configuration of a multimodal protocol network coupled to the network from FIG. 2.

FIG. 6 is a functional diagram illustrating a configuration of multimodal protocol utilizing a session storage device in the network from FIG. 4.

FIG. 7 is a functional diagram illustrating an embodiment of a user device that may be configured to communicate via a communications network such as the network from FIGS. 1, 2, 4, and 5.

FIG. 8 is a flowchart diagram illustrating actions that may be taken when changing from a first device to a second device pursuant to a network configuration such as the configuration from FIG. 5.

FIG. 9 is a flowchart diagram illustrating possible steps that may be taken to send session information in a network configuration such as the configuration from FIG. 4.

FIG. 10 is a flowchart diagram illustrating possible steps that may be taken to receive session information in a network configuration such as the configuration from FIG. 4.

FIG. 11 is a flowchart illustrating possible steps that may be taken when a first user indicates a change with respect to a second user device, in a network configuration, such as the network configuration from FIG. 4.

FIG. 12 is a flowchart illustrating alternate steps that may be taken when a first user indicates a change with respect to a second user device, in a network configuration, such as the network configuration from FIG. 4.

FIG. 13 is a flowchart diagram illustrating possible steps that may be taken when a user receives a communications session in a communications network such as the network from FIG. 4.

FIG. 14A is a flowchart diagram illustrating possible steps that may be taken when a communications network loses a communications session such as in the network from FIG. 4.

FIG. 14B is a continuation flowchart diagram from FIG. 14A.

FIG. 15 is a flowchart diagram illustrating possible steps that may be taken when a communications network loses a communications session such as in the network from FIG. 4.

FIG. 16 is a flowchart diagram illustrating possible steps that may be taken when utilizing a session storage device such as the device from FIG. 6.

FIG. 17 is a flowchart diagram illustrating possible steps that may be taken when a communications network loses a communications session such as in the network from FIG. 5.

FIG. 18 is a flowchart diagram illustrating possible steps that may be taken in facilitating a device change in a network configuration, such as the configuration from FIG. 5.

FIG. 19A is a flowchart diagram illustrating possible steps that may be taken in facilitating a mode change in a network configuration, such as the configuration from FIG. 5.

FIG. 19B is a continuation flowchart diagram from FIG. 19A.

### DETAILED DESCRIPTION

This disclosure discusses providing a mechanism for maintaining user session information, context, and state when the user accesses applications either from the same service provider or from a plurality of service providers. In addition, this disclosure discusses providing a mechanism that allows users to move to a new location or use a different device to continue an application. Using a new device, the user may or may not have the same functionality as the previous device. As a nonlimiting example a user may implement voice functionality with a first device, and may have multimodal exchange (multifunctional such as voice and visual) with the second device.

In at least one embodiment, this disclosure discusses the use of an Extensible Markup Language (XML) framework for defining context information and the use of this information to carry the context of a previous application experience or transaction forward for reuse in a subsequent application. Further, this contextual information can be available in real-time from central network based storage logic, data storage device, or database or client-based storage logic, data storage device or database.

This information can be used real-time by complimentary applications provided by different service providers and hosted on different servers. The XML data can be archived and used to provide a common knowledge base for referencing and mediation. Additionally, the data can be used to dynamically change or override for this occurrence profile information in a preexisting profile database including, but not limited to an Information Management System (IMS) database or a High-Speed Serial (HSS) database, or using other storage techniques.

Accordingly, a framework using Metafiles and XML constructs reflects both global and service specific variables. At least one embodiment includes varying the location of the context information in a network or client location (or a combined effort based on content priority and desired owner control). As a nonlimiting example, many secure and high priority systems generally utilize a client's position with tight secured data access, thereby providing a desired ownership and control over its use. Conversely, the lower cost and lower privacy items can use a network server where the content is managed for the user. As discussed below, as client devices become more empowered, content more will likely be kept with the client, and only passing use of the network server will remain for global information.

At least one embodiment of the present disclosure includes the mediation of framework elements, such as defined priorities, user preferences, user schedules, legal constraints, and local norms. The mediation process can allow services to utilize contextual information, automatically querying the client or the application. Mediation rules are defined by common business or preference logic defined by the user or by the industry that is common to the service provided. Disambiguation of conflicting rules occurs first between the servers per defined priorities then, if desired with the user of the service. The hierarchy of data as appropriate for a voice or multimodal service may include at least one of the following: time of day, day of week, location, contact information (such as phone numbers or email addresses, etc.), conclusions relative to an action or event, amounts, dates, and preferences (such as food, airlines, restaurants, entertainment, etc.). The mediation process can include determination of desired information when recent context of an application session is inconsistent with the profile information stored in a network. The desired information can be selected in any of a plurality of ways including reference to priorities related to the industry or service with which the communication session is associated.

Additionally, at least one embodiment can also include a chain of communications where session data is maintained through the various communications. As a nonlimiting example, a user (or server) can make a telephone call to a restaurant (or a server for a restaurant) to make reservations. The user can make the reservations and then call a movie theater (or server for a movie theater) to purchase movie tickets. If the user determines that the desired movie is only played at a time that conflicts with the reservations, the user may call the restaurant again to change the reservations. At this point the session information can be updated to convey the new reservation time.

If, after the reservations are changed, the user wishes to call a taxi company to schedule for transportation from the restaurant to the movie theater, the session information can convey the updated information to the taxi company. The Taxi Company can access the desired information from Metadata that was created for the current session. As stated above, the Metadata can be conveyed via an XML framework that can be communicated to the Taxi Company from any of a plurality of sources. Alternatively, the session information may convey both the canceled reservations and the new reservations if such information is desired. System mediation ends with a query to the caller for an optional confirmation of the automated mediation or a summary exchange with the called application for the desired outcome.

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

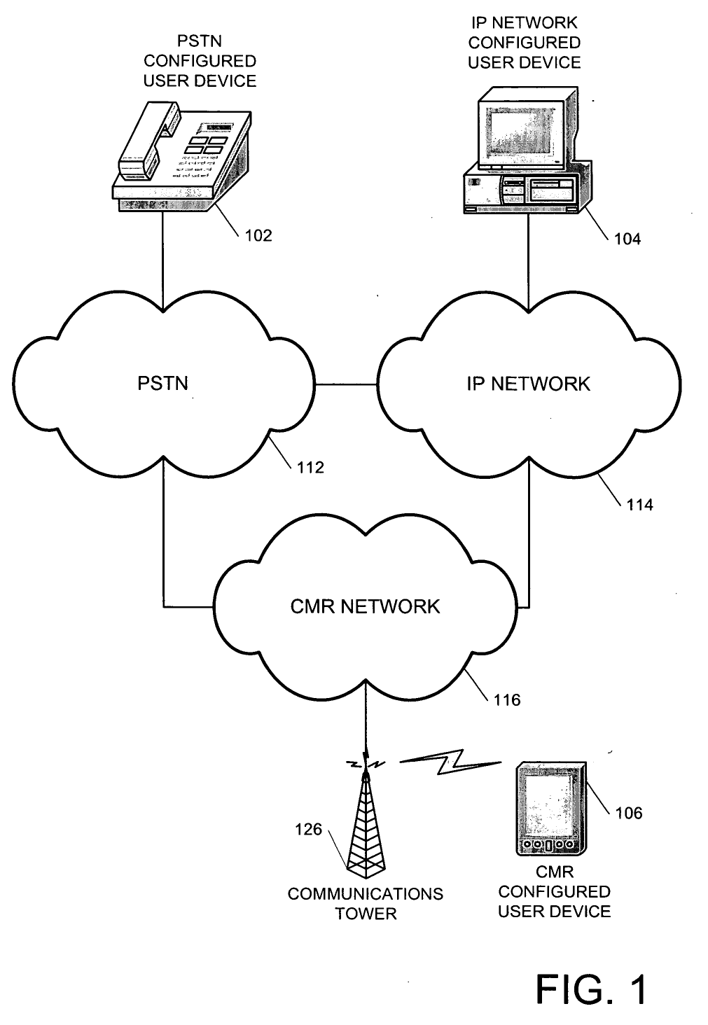

FIG. 1 is a functional diagram illustrating an embodiment of a communications network configuration. As illustrated in FIG. 1, a communications network may include a plurality of networks, such as a Public Switched Telephone Network (PSTN) 112, a Cellular Mobile Radio (CMR) network 116, which may include at least one communications tower 126, and an Internet Protocol (IP) network 114 among others. The PSTN 112 may be coupled to at least one PSTN configured user device 102. The PSTN configured user device 102 may be a conventional telephone, a wireless telephone, a personal computer, or other device.

Similarly, the IP network 114 may be coupled to at least one IP network configured user device 104. The IP network configured user device 104 may include a personal computer, a telephone, or wireless device (such as a pocket personal computer), or other device configured to communicate using an IP network. Further, a CMR configured user device 106 may be coupled (wired or wirelessly) to a communications tower 126, which can facilitate communications with the CMR network 116. One should note that while FIG. 1 represents communications tower 126 as a structural tower, this is not intended as a limitation. Communications tower 126 may take many forms such as a satellite or other facilitator of communications with a CMR network.

Additionally, while CMR configured user device 106 is illustrated as coupling wirelessly with the communications tower 126, this is not intended as a limitation. Further, IP network configured user device 104 and PSTN configured user device 102 may also communicate wirelessly or via a wired communications medium, depending on the particular configuration. The purpose of this disclosure is not to limit the subject matter in this or other manners.

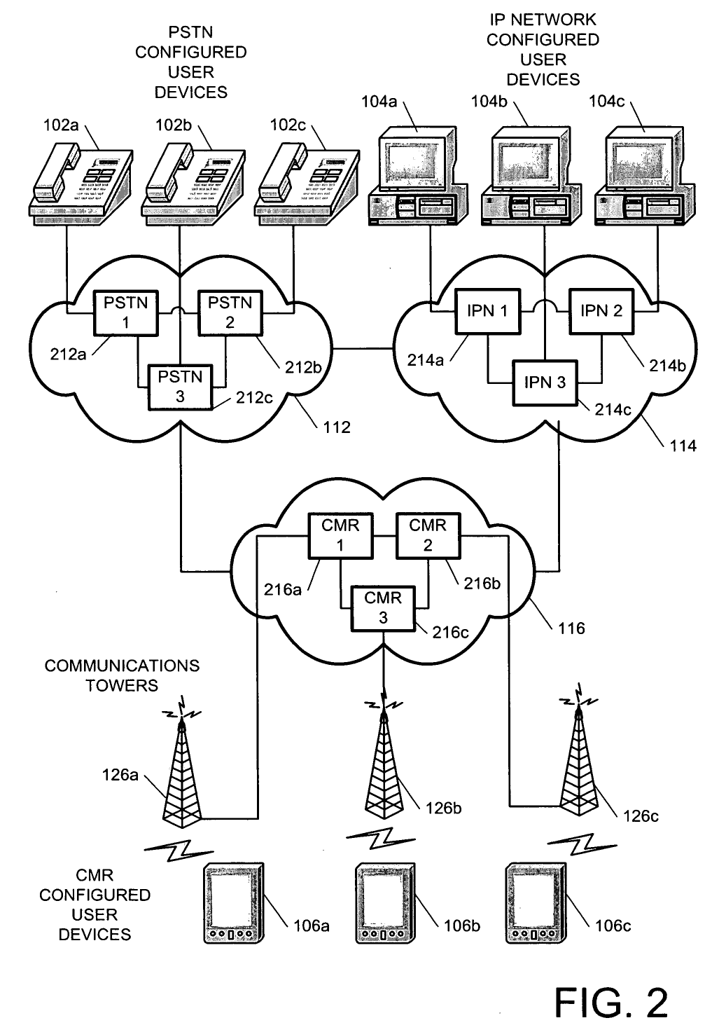

FIG. 2 is a functional diagram illustrating a detailed view of a communications network configuration, similar to FIG. 1. As illustrated, the PSTN 112 includes a plurality of PSTN configured user devices 102a, 102b, 102c, each coupled to a PSTN sub-network 212a, 212b, 212c, respectively. In at least one embodiment PSTN1 212a is a PSTN of one communications protocol, while PSTN2 212b is a PSTN of another protocol. PSTN3 212c is a communications protocol different than both PSTN1 212a and PSTN2 212b.

Similarly, user devices 104a, 104b, 104c are each coupled to IPN1 214a, IPN2 214b, IPN3 214c, respectively. In at least one embodiment, each of these sub-networks is configured to communicate in a protocol different than the other two. As a nonlimiting example, IPN1 214a can be a DSL communications network, while IPN2 214b can be a cable-based IP network. IPN3 214c may be a communications network that conforms to another protocol, which is different than IPN1 214a, or IPN2 214b.

CMR network 116 may be coupled to CMR configured user devices 106a, 106b, 106c via communications towers 126a, 126b, 126c. Each CMR configured user device 106a, 106b, 106c is coupled to a CMR1 216a, CMR2 216b, CMR3 216c, respectively. Each CMR sub-network 216a, 216b, 216c may be configured to communicate data pursuant to a different communications protocol. As a nonlimiting example, CMR1 216a may be configured to communicate via a Personal Communications Services (PCS), while CMR2 216b may be configured to communicate via an analog cell phone protocol, while CMR3 216c may be configured to communicate via a digital service protocol.

Although PSTN configured user device 102a may be a PSTN-based communications device, a user may establish a communications session with CMR configured user device 106c, regardless of the fact that the two users are implementing devices that utilize different protocols. As with any of the devices illustrated in these nonlimiting examples, users of devices that operate via different protocols may generally establish a communications session.

Similarly, one should also note that while only one user device is coupled to each sub-network, this is for discussion purposes only. As one of ordinary skill in the art will understand, any number of communications devices may be coupled to a single sub-network.

Additionally, while each of these sub-network protocols may be different, this is but a nonlimiting example. In at least one embodiment, IPN1 214a and IPN2 214b may communicate via compatible protocols (or the same protocol), however communication of certain data may be inhibited because the service provider of IPN1 214a and IPN2 214b are different entities. One should therefore note that for whatever reason, session information and other data may not generally be communicated on an inter-network basis.

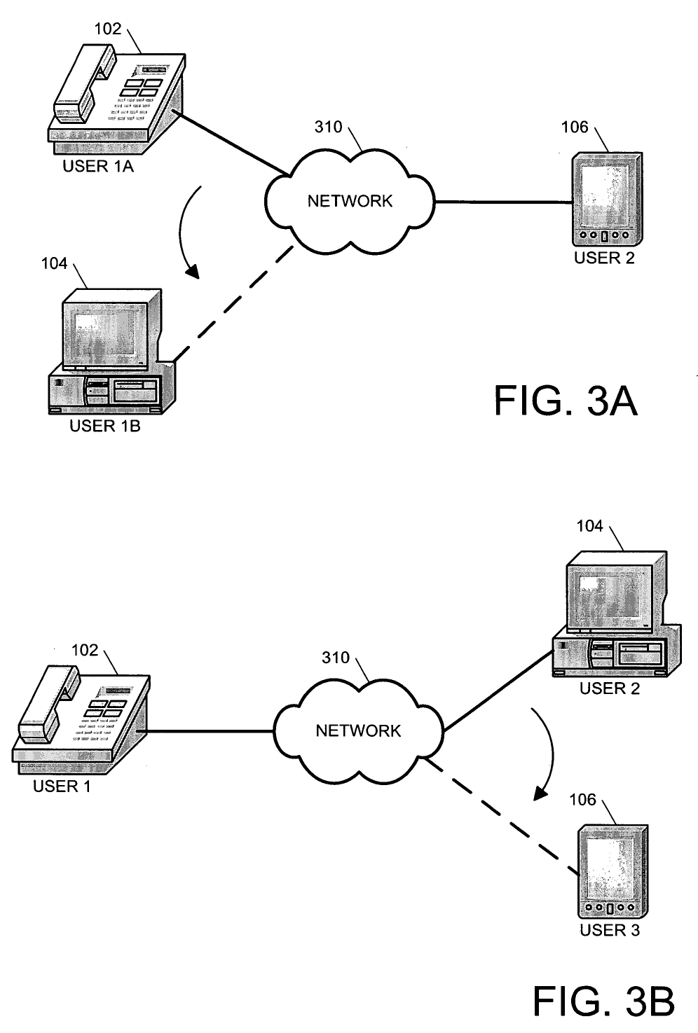

FIG. 3A is a functional diagram illustrating a first user changing devices during a communications session which may occur in a network configuration, such as the configuration from FIG. 1 or 2. As illustrated, user device 102 may be configured to communicate via a PSTN, such as PSTN1 212a, which may be located somewhere within network 310. Similarly, the second user may be communicating via user device 106, which may be configured to communicate via a CMR network, such as CMR1 216a, which may also be located within network 310. At some point during the communications session, the first user may desire a device change from user device 102 to user device 104. While this nonlimiting example includes a device change, it is conceivable that the first user desires to maintain communications via the first user device 102, but simply desires a mode change with respect to that device. A mode change can include changing functionality of the device, such as changing from a voice communication to a voice and video communication, or changing from a data communication to a voice communication. One should note that the above listed examples are meant to be nonlimiting, as any change in device functionality is contemplated in this disclosure. One should also note that a mode change can also include a change in service providers with or without changing device functionality.

Alternatively (or supplementally) a mode change can include changing service providers with or without changing modes or devices. In any event, the device or mode change can include a mediation process that facilitates maintaining or resuming a current session. As a nonlimiting example a user can initiate a communications session with an Internet Service Provider (ISP) via an IPN. The user may determine that the current ISP is not as desirable for this communications session as a different ISP. The user can then facilitate changing from the first service provider to the second service provider while maintaining session information.

One should also note that although FIGS. 3A and 3B illustrate the device change as occurring with devices of different protocols, this is but a nonlimiting example. As is evident to one of ordinary skill in the art, the device change may include two (or more) devices of the same protocol.

FIG. 3B is a functional diagram illustrating a second user changing devices during a communication session, which may occur in a network configuration, such as the configuration from FIG. 1 or 2. This scenario may occur when a first user desires to purchase movie tickets as well as make dinner reservations. After purchasing the movie tickets, the user may wish to make reservations, while maintaining the information regarding the movie ticket purchase.

As described in detail below, the first user may disconnect communication with the second user, while maintaining the session (and session information). The user can then connect with the third user, thereby communicating the session information. In another nonlimiting example, the first user can simply transfer the communication session from the second user to the third user while maintaining session information. One should note, however, that the transfer implementation from the second user to the third user may take many forms.

One should also note that in at least one embodiment, the device change can take place if the communications link established between the first user and the second user is severed (e.g., the first user's cellular telephone loses service). In this situation the first user may desire to change to a device that can reestablish the communications link and continue the communications session.

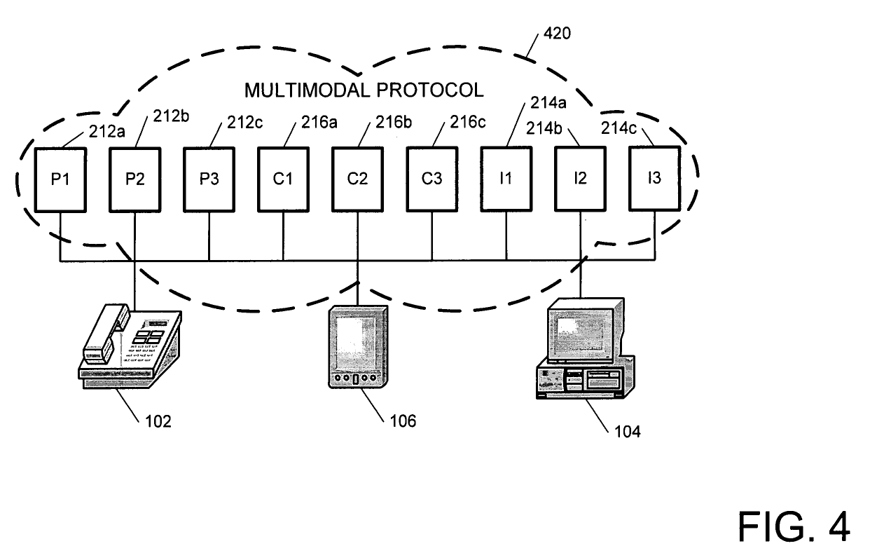

FIG. 4 is a functional diagram illustrating a configuration of a multimodal protocol implemented with the network configuration from FIG. 2. As illustrated, user devices 102, 104, 106 are coupled to the plurality of sub-networks 212a, 212b, 212c, 214a, 214b, 214c, 216a, 216b, 216c. However, in this nonlimiting example, each sub-network listed above adheres to a multimodal protocol 420 for the communication of session information. In at least one embodiment, the multimodal protocol is a way for different communications sub-networks to communicate data on an inter-network scale. With a multimodal protocol, such as multimodal protocol 420, a user can begin a communications session with one user device, and change user devices during the same communications session. As a nonlimiting example, the multimodal protocol can take the form of an XML framework that provides a means for transfer of session information.

As an additional nonlimiting example, a first user may make a telephone call to a second user using PSTN configured user device 102. During that communications session, the first user may decide that the conversation would be better-suited using CMR configured user device 106. As such, the first user can send an indication that the user device 102 will change. This indication can be communicated to the second user, whose user device can record the session information, along with information relating to user device 106. The first user can then resume the communications session with CMR configured user device 106. Despite the fact that the PSTN configured user device 102 and the CMR configured user device 106 communicate using different protocols, this change can be completed in real-time.

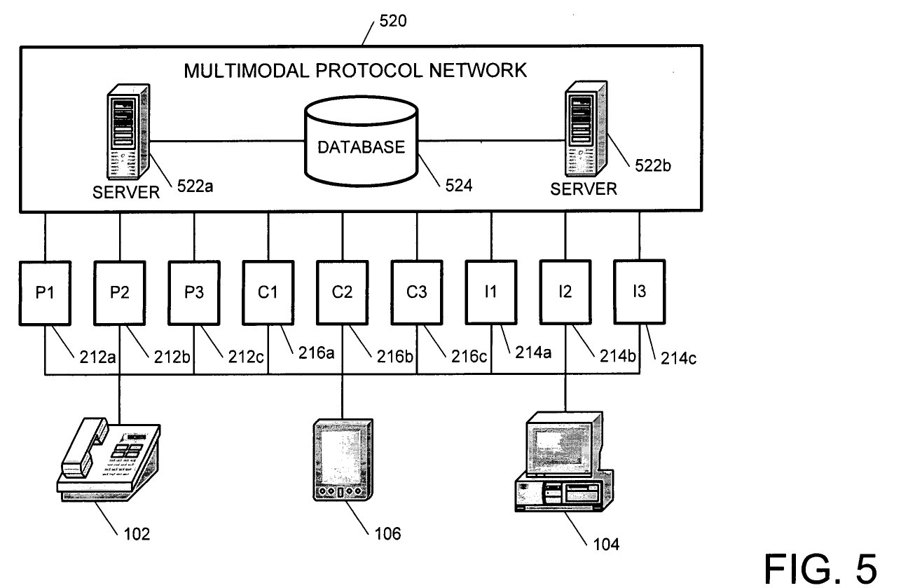

FIG. 5 is a functional diagram illustrating a configuration of a multimodal protocol network coupled to the network from FIG. 2. As illustrated, the sub-network components 212a, 212b, 212c, 214a, 214b, 214c, 216a, 216b, 216c are coupled to PSTN configured user device 102, CMR configured user device 106, and IPN configured user device 104. Also coupled to the sub-network components listed above is a multimodal protocol network 520. The multimodal protocol network 520 may include at least one server 522a, 522b, and at least one data storage device or data storage logic, represented by database 524. The multimodal protocol network 520 can be configured to facilitate multimodal communications both in terms of device changes and functionality changes during a communications session. As stated above with respect to the multimodal protocol 420 in FIG. 4, the multimodal protocol network 520 can be configured to operate with an XML framework, which can thereby facilitate communication with various networks and sub-networks. As is evident to one of ordinary skill in the art, this is but a nonlimiting example.

As a nonlimiting example, referring back to FIG. 3A, a first user on PSTN configured user device 102, places an audio telephone call to a second user on CMR configured user device 106. When the call is placed, the multimodal protocol network 520 can be configured to retrieve data regarding the first user's device (PSTN user device 102), the second user's device (CMR user device 106), and other information that may be potentially useful. Referring back to FIG. 5, this information can be stored in database 524. Additionally, the multimodal protocol network 520 may also store previous information regarding the first user and the second user, such as data related to other devices that user commonly uses for communication. Alternatively (or supplementally), either of the sub-networks may store some or all of this data. When a communications session is created, this information may be forwarded to multimodal protocol network 520 including session information appropriate for the current session.

Once the communication session begins, various information regarding the session may be continuously recorded. If, at some point during the communications session the first user decides that video is also desired for this communications session, the user may send an indication to the multimodal protocol network 520 regarding a device change to IPN configured device 104 is desired. The Multimodal protocol network 520 can be configured to send data to the second user's device (in this example CMR configured user device 106) regarding the first user's new device (IPN configured user device 104). Similarly, the session data may be communicated to the IPN configured user device 104 via the appropriate IP sub-network 216a, 216b, 216c. The first user can then activate the IPN configured user device 104.

Alternatively, the first user may not wish to change devices, but to simply change from an audio telephone call to a multimodal (such as audio and video) telephone call. Assuming that the PSTN configured user device 102 (which is the communications device that the first user used to originate the communications session) has video capabilities, the first user can send an indication to the multimodal protocol network 520 that a mode change is desired. The multimodal protocol network 520 can query the second user's current device (in this example CMR configured user device 106) or can retrieve data regarding that device in database 524 to determine whether the second user supports a multimodal telephone call. If the multimodal protocol network 520 determines that the second user's device supports this option, the multimodal protocol network queries the second user to determine whether a mode change is desired. If the second user answers in the affirmative, the mode may be changed.

If the multimodal network 520 determines that the second user does not support a multimodal telephone call, the multimodal network 520 can query the second user to determine whether a device change is desired. If the second user replies in the affirmative, the multimodal protocol facilitates that device change, and facilitates the mode change. At this point, the communications session now supports both voice and video.

In an alternate embodiment, a first user may initiate a communication to a second user, such as a movie theater. The first user may designate when the communications session begins by initiating the communication, or actively initiating the communications session after a communications link with the second user is established. Once the communications session begins, the first user may receive information regarding possible movie showings at this movie theater. Depending on the particular embodiment, the first user may listen to movie reviews, preview the movies, and purchase tickets during the communications session. Without ending the communications session, the first user may desire a device change on the second user's end. As a nonlimiting example, the first user may desire to now be connected with a restaurant that was previously selected by the user.

The user can indicate this desire in any of a number of ways including communicating to the multimodal protocol network 520 that the communications session is not ending. The user can then disconnect with the movie theater, and connecting with the restaurant. Alternatively, the first user may have an option to simply transfer to the restaurant. Regardless of the means of transfer, the first user has indicated that the communications session has not ended.

Once the first user is connected with the restaurant (or restaurant server or restaurant application platform), the restaurant may have access to various information regarding this communications session. Some examples of this information may include the movie tickets purchased, total session time, etc. This information can help the restaurant provide better service regarding potential reservations for the first user.

Additionally, the restaurant can also maintain communication regarding the communications session after the session has ended. As a nonlimiting example, the restaurant may maintain (or establish) a communication with the movie theater to determine when the movie ends, so the restaurant can better determine the approximate time the first user will likely arrive for the reservations. The restaurant, may also communicate with a network resource to determine the most likely route the user may take to arrive at the restaurant, to further determine the approximate time of arrival.

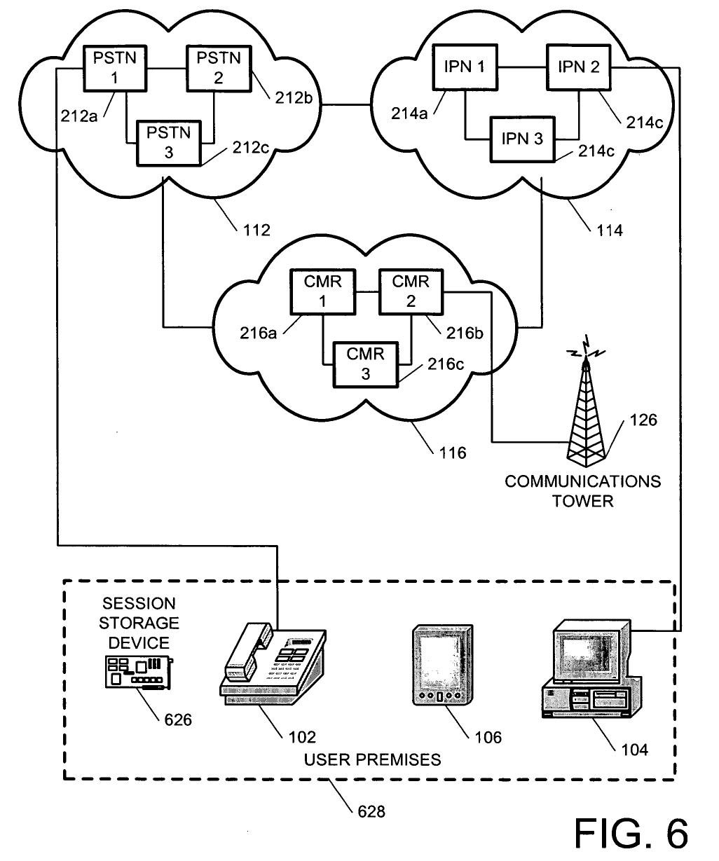

FIG. 6 is a functional diagram illustrating a configuration of multimodal protocol utilizing a session storage device in the network from FIG. 4. Similar to FIG. 2, this configuration includes PSTN1 212a, PSTN2 212b, PSTN3 212c associated with PSTN 112. Additionally IPN1 214a, IPN2 214b, IPN3 214c are associated with IP network 114. Further, CMR1 216a, CMR2 216b, CMR216c are associated with CMR network 116.

Similarly, PSTN configured user device 102 is coupled to PSTN1 212a. CMR configured user device 106 is coupled to CMR2 216b via communications tower 126. IPN configured user device 104 is coupled to IPN2 214b. However, in this nonlimiting example PSTN configured user device 102, CMR configured user device 106, and IP network configured user device 104 are located at user premises 628. Also included in this nonlimiting example is a session storage device 626.

Session storage device 626 may be configured for insertion in one of the user devices 102, 104, 106 when a communications session begins. The session storage device 626 can be configured to store the session information for the current communications session. If a user desires to change devices, the session storage device 626 (which can take the form of a Subscriber Identity Module or SIM card, or other storage device) can be removed from the first device and inserted to the second device. At this point the communications network to which the new device is associated can read the data stored on the session storage device 626, to reconnect the current session.

As a nonlimiting example, a first user can insert the session storage device 626 into CMR configured user device 106 when a communications with a second user begins. The CMR configured user device 106 can communicate various session data to the session storage device 626. The data can originate from the second user's device, or from a network that is facilitating the communications session. As the communications session progresses, data can be continuously stored on the session storage device 626. If the first user determines that the current communications session is more suited for PSTN configured user device 102, the first user can remove the session storage device 626 from the CMR configured user device 106, and insert it into PSTN configured user device 102. The PSTN configured user device 102, coupled with the session storage device 626 can communicate various data regarding the session and PSTN configured user device 102 capabilities with a communications network to reestablish the communications session.

As is evident to one of ordinary skill in the art, although FIG. 6 includes the various user devices 102, 104, 106 as being located at a user premises, this is but a nonlimiting example. The user devices need not reside at a common locale, as a user could conceivably remove the session storage device 626 and transfer the session storage device 626 to a user device at a different location. As long as the current session has not been severed, the transfer of the session storage device 626 from one device to another need not be instantaneous. Additionally, the session storage device 626 need not be physically coupled to a user device. As is evident to one of ordinary skill in the art, the session storage device can include logic that is communicatively coupled to the user device, such as storage logic in a home network. In such a nonlimiting example, each user device can communicate with the home network to maintain session information.

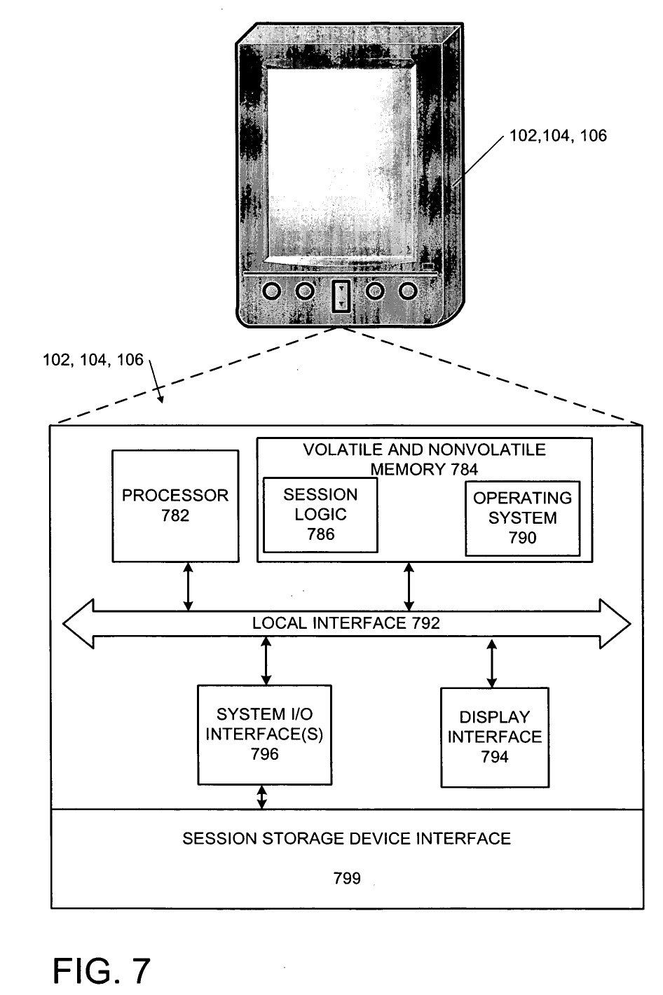

FIG. 7 is a functional diagram illustrating an embodiment of a user device that may be configured to communicate via a communications network such as the network from FIGS. 1, 2, 4, and 5. Although the CMR configured user device 106 is illustrated, this discussion can be applied to any user device. The user device 102, 104, 106 may include a processor 782 that is coupled to a local interface 792. Also coupled to the local interface is a volatile and nonvolatile memory unit 784, which can include an operating system 790 and session logic 786. Also coupled to the local interface 792 is a display interface 794 and system input/output interface(s) 796. Also included with the user device 102, 104, 106 is a session storage device interface 799.

As is evident to one of ordinary skill in the art, the session storage device interface 799 could be part of system I/O interface(s) 796. However, for purposes of this nonlimiting example, session storage device interface 799 is represented as being coupled to system I/O interface(s) 796. As is also evident to one of ordinary skill in the art, while this representation includes various components that can be present in a user device, this is but a nonlimiting example. Depending on the particular embodiment, components may be removed or added to the representation of FIG. 7. Similarly, while the representation of FIG. 7 illustrates the various components as hardware, this is also a nonlimiting example. Any combination of programmable medium and logic may be configured to implement the functions described herein.

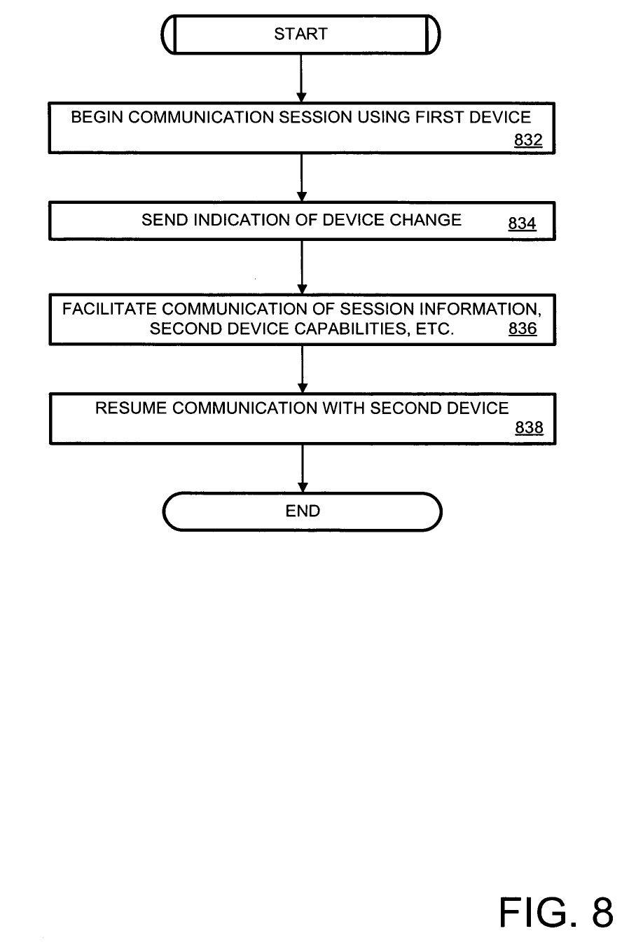

FIG. 8 is a flowchart diagram illustrating actions that may be taken when changing from a first device to a second device pursuant to a network configuration such as the configuration from FIG. 5. As shown, the first step a user may take is to begin a communication session using a first device (block 832). To perform this step, the user may simply dial a telephone number, receive a telephone call, send an e-mail, receive an e-mail, send an instant message, receive an instant message, or otherwise facilitate a communication with a second user.

Once the communication session begins, the user can send an indication of a device change (block 834). The present disclosure contemplates any number of types of device changes, including but not limited to changing from a PSTN configured user device 102 to a CMR configured user device 106. In this nonlimiting example, the user may indicate a desire to change devices through any number of possible actions. In at least one embodiment, the user can press a button on the PSTN configured user device 102, which can indicate to PSTN 212a that a device change is requested.

Once a device change is requested, the user can facilitate communication of session information, second device capabilities, and other information that may be material to the current session (block 836). In at least one embodiment, the PSTN network can store session information, while other embodiments may include a multimodal network configured to store session information. Regardless of the means for storing the session information, the user can facilitate the communication of this information to indicate to the second network (which, in this nonlimiting example is the CMR sub-network 216a) that a current session will include a device coupled to the second network. The user can activate the second device (and thereby indicate that this is the device that will resume the communications session), and resume the communication with the second device (block 838).

As is evident to one of ordinary skill in the art, the user's awareness of the inter-workings of the transfer from the first device to the second device may be seamless. A user may simply press a button on the first device, and begin talking on the second device. In at least one embodiment, voice recognition logic can receive a voice signal from the user on the second device, and thereby determine that this is the device with which the session will continue. In at least one other embodiment, the user can communicate a signal via a series of keystrokes that can indicate that this is the device that will resume the communication.

As is also evident to one of ordinary skill in the art, a user can take any of a variety of actions to indicate a desire to change devices (or modes). While activating a button on a first device may be one action that may be taken, other types of indications may also be acceptable, depending on the particular implementation.

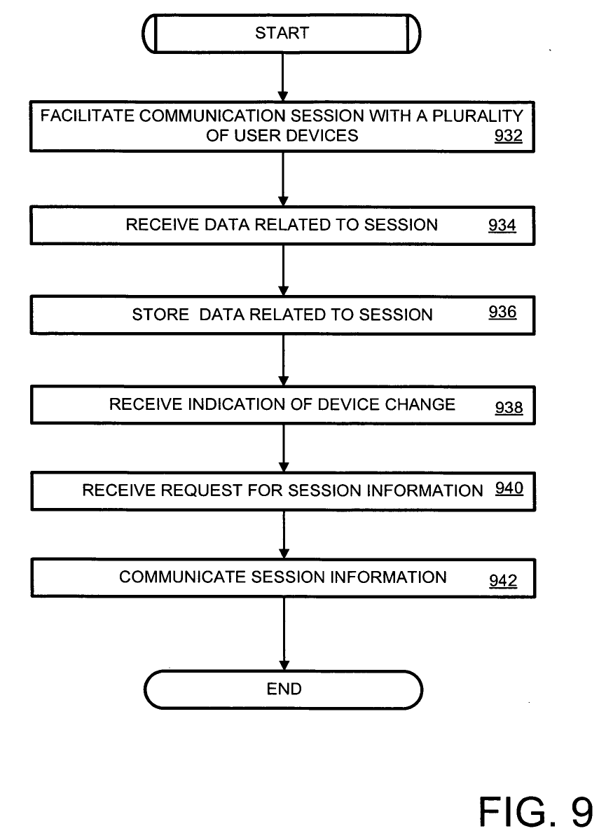

FIG. 9 is a flowchart diagram illustrating possible steps that may be taken to send session information in a network configuration such as the configuration from FIG. 4. In this nonlimiting example, the first step is to facilitate a communication session with a plurality of user devices (block 932). This step can be performed by any of the networks or sub-networks illustrated in FIGS. 1-6. Once the communication session is established, data related to the current session may be received (block 934). The session data may then be stored continuously, periodically, or otherwise (block 936). The data stored may include session length, session start time, devices used, networks utilized, device capabilities, etc., or any combination of these.

In at least one nonlimiting example, a user participating in a communications session may desire a device change, such as a change from a PSTN configured user device 102 to a CMR configured user device 106. In a multimodal configuration such as illustrated in FIG. 4, the PSTN1 212a may receive this data, although this is not a requirement. Next, PSTN1 212a may receive a device change request from a user (block 938). The request may or may not include information related to the new device. Next, the PSTN1 212a may receive a request from the second device for session information (block 940). This request may come from the communications network associated with the second device (in this nonlimiting example, CMR1 network 216a). The CMR1 network 216a may request session information for communication to the second user device (CMR configured user device 106). The second user device may utilize this information to connect with the current session. Next, the session information can be communicated (block 942). Once the session information is communicated, and the second user device is participating in the communications session, the user may disconnect the first user device from the session. Alternatively, this may be accomplished automatically when the second user device begins participating in the communications session. One should note that while this disclosure discusses transferring from one user device to another, there is no limitation requiring that the first user device disconnect from the communications session. The first device may remain in the communications session, along with the second user device.

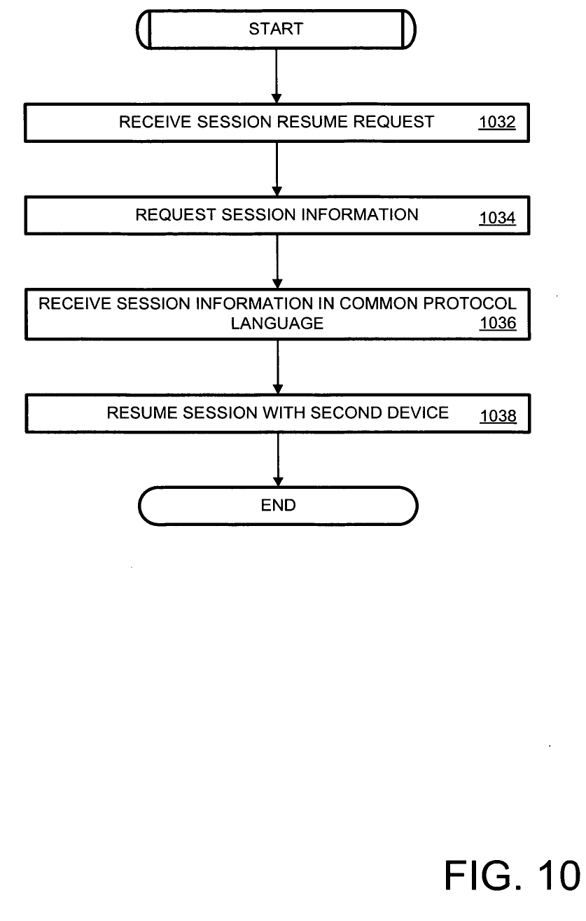

FIG. 10 is a flowchart diagram illustrating possible steps that may be taken to receive session information in a network configuration such as the configuration from FIG. 4. As the nonlimiting example from FIG. 9 discusses steps related to a network that is coupled to the first user device, this nonlimiting example can be directed to the network of the second user device. The first step in this nonlimiting example is to receive a session resume request (block 1032). The session resume request may originate from the second user device. Next, the network may request session information (block 1034). This request may be directed to the communications network coupled to the first user device, or to a multimodal network. Next, the network coupled to the second user device may receive session information in a common protocol language such as XML or other comparable language (block 1036). The common protocol language may be any communications language that the network coupled to the first user device and the network coupled to the second user device can both understand. Once the session information is received, the second network can resume the communications session, using the second user device (block 1038).

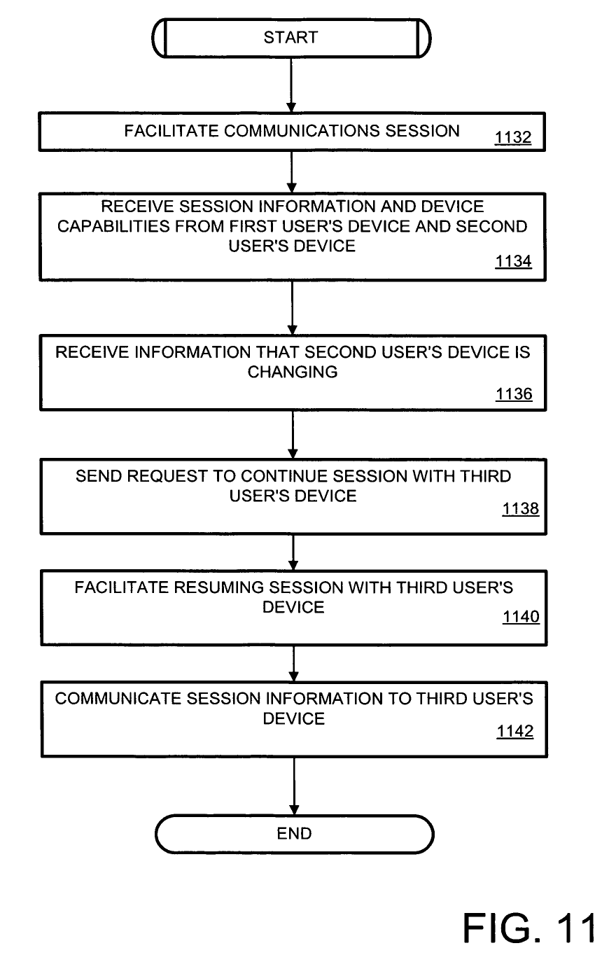

FIG. 11 is a flowchart illustrating possible steps that may be taken when a first user indicates a change with respect to a second user device, in a network configuration, such as the network configuration from FIG. 4. While the previous nonlimiting examples discuss a scenario where a first user desires to change devices, this nonlimiting example discusses a scenario where the first user desires that the second user's device change. As discussed above, such a situation may occur when the first user is both purchasing movie tickets and making dinner reservations. Similarly as discussed above, this transition may occur in any of a plurality of ways. One such way is discussed in reference to FIG. 11.

While the steps illustrated in FIG. 11 may be directed to any of a number of different entities, this discussion will describe these steps in reference to the first user's network. More specifically, in this nonlimiting example, a first user is using an IP network configured user device 104. The second user is a movie theater, who is communicating with the first user via a PSTN configured user device 102. The first user wishes that the second user's device change to a PSTN configured user device 102 that is controlled by a predetermined restaurant. In this nonlimiting example, the IP network 214a may perform the actions discussed with respect to FIG. 11.

The first step of this nonlimiting example is for the first user's network to facilitate a communications session with the second user's device (block 1132). Next, the first user's network can receive session information and device capabilities from the first user's device and the second user's device (block 1134). As discussed above, the network can store this information continuously or periodically, however this is not a requirement. Next, the first user's network can receive information from the first user's device that the second user's device is changing.

Once the session information is received, the network can receive information that the second user's device is changing. (block 1136). In at least one nonlimiting example, the information may be received from the first user's device. However, this is not a requirement. Then, the network can send a request to continue the current session with the second user's new device (which, in fact may be a third user's device, as illustrated in FIG. 3B (block 1138).

Next, the network can facilitate resuming the current session with the new device (block 1140). This step may simply include assisting the connection of the new device to the current session. In the final step of this nonlimiting example, the network can communicate session information to the new device (block 1142).

As stated with reference to FIGS. 3A and 3B, the networks associated with each device may be different, both in terms of protocol, and in terms of network type. The first user's device may utilize a PSTN network, while the second user's device may utilize an IP network, and the third user's device may utilize a CRM network. Alternatively, the user's devices may utilize the same type of network, but simply communicate via different protocols. (e.g., IPN1, IPN2, IPN3). However, one should note that the users' devices could, in fact utilize the same type of network in the same protocol. The intention of this disclosure is to emphasize that the network type and protocol are irrelevant.

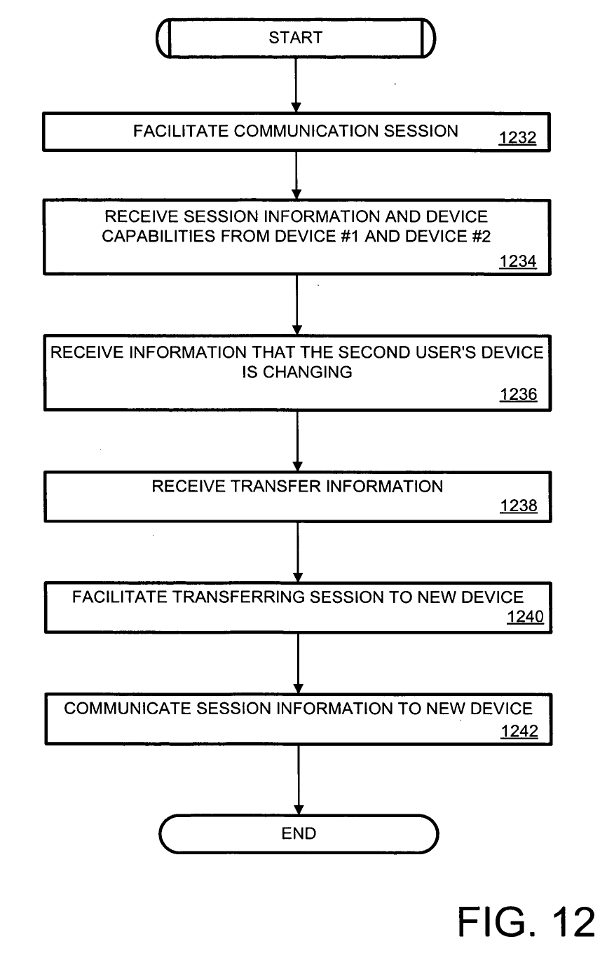

FIG. 12 is a flowchart illustrating alternate steps that may be taken when a first user indicates a change with respect to a second user device, in a network configuration, such as the network configuration from FIG. 4. As discussed with respect to the FIG. 11, this nonlimiting example may be directed to the first user's network, however this is not a requirement. As is evident, these and similar steps may be utilized with any of a plurality of components.

As illustrated, the first step of this nonlimiting example is to facilitate a communications session (block 1232). The communication session may take place between a first user utilizing a first user device, and a second user utilizing a second user device, however this is not a requirement. Once the communication session is established, the network can receive session information and device capabilities from the first user's device and the second user's device (block 1234). The session information can be stored on the first user's network or the second user's network, or both. Then, the network can receive information that the second user's device is changing (block 1236).

The next step in this nonlimiting example is to receive transfer information (block 1238). The transfer information may be received from the first user's device, however, in some cases, the second user may initiate the transfer, and send the transfer information to the first user's network. The transfer information may include the location, network, and protocol of the new user device. Also included in the transfer information can be information provided to the first user regarding the new user. Once the transfer information is received, the network can facilitate transferring the session to the new device (block 1240). This step may involve locating the new device, and performing a handshake or authentication with the new device, although these procedures are not required by this disclosure. Once the connection with the new device is established, the network can communicate the session information to the new device (or the network associated with the new device) as shown in block 1242.

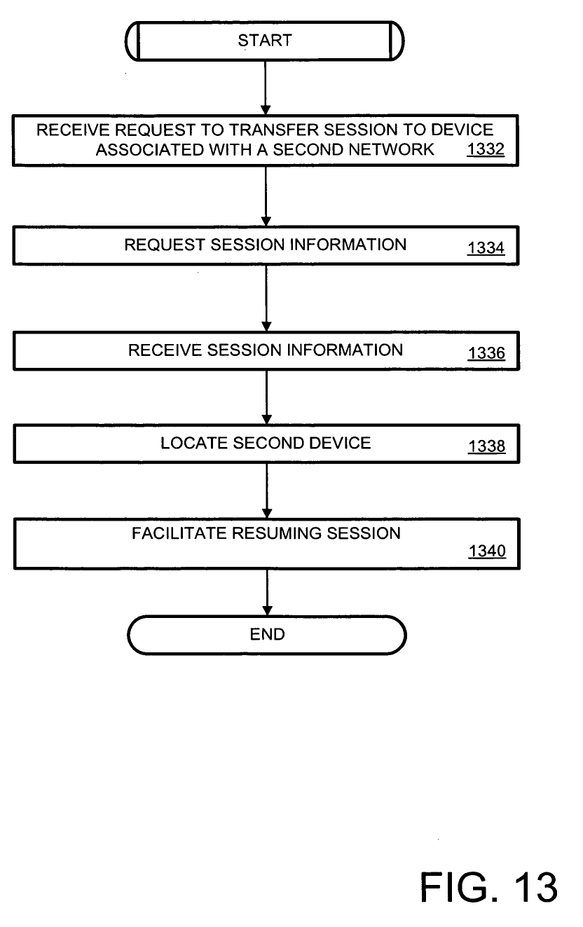

FIG. 13 is a flowchart diagram illustrating possible steps that may be taken when a user receives a communications session in a communications network such as the network from FIG. 4. The first step in this nonlimiting example is to receive a request to transfer the current session to a device associated with a second network (block 1332). The request may derive from a network associated with the first device (which is getting replaced or complimented, as illustrated in FIG. 3A), however, it is contemplated that this request originates from elsewhere. Once the request is received, the network can request session information (block 1334). The request can be directed to the first user device, to an external network, or even to a data storage unit associated with the current network.

The next step in this nonlimiting example is to receive the session information (block 1336). From the received session information, the network can locate the second device (block 1338). While in at least one embodiment the second device is located on a second network, this is not a requirement. As discussed above, the second device may be associated with the same network and protocol as the first network. Next, the network can facilitate resuming the session on the network (block 1340).

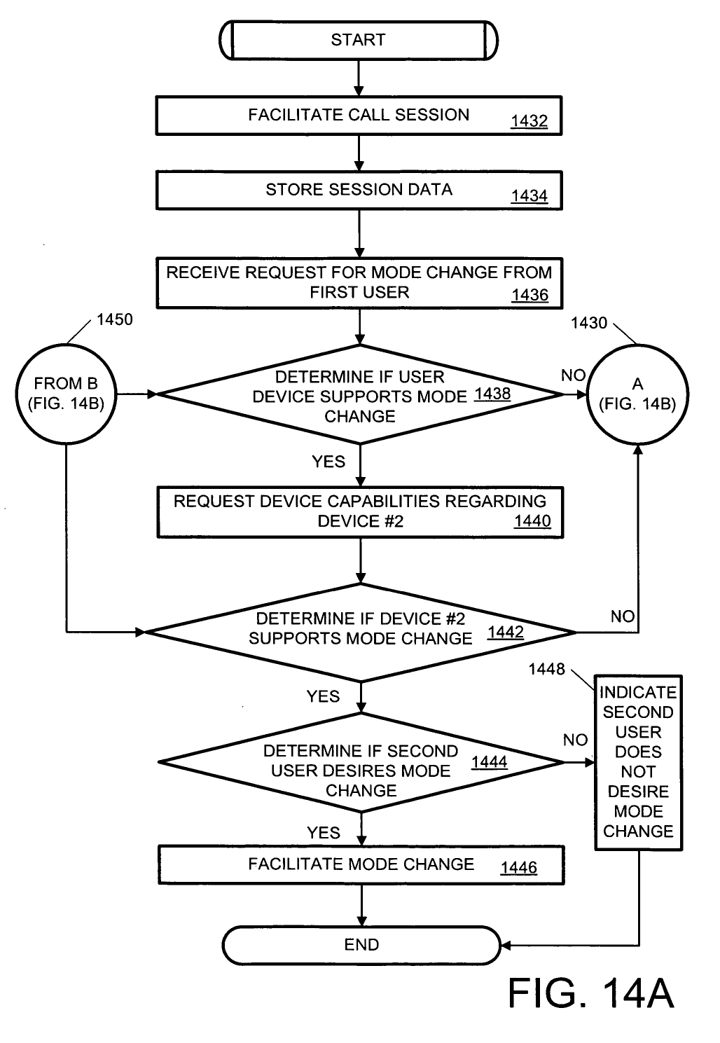

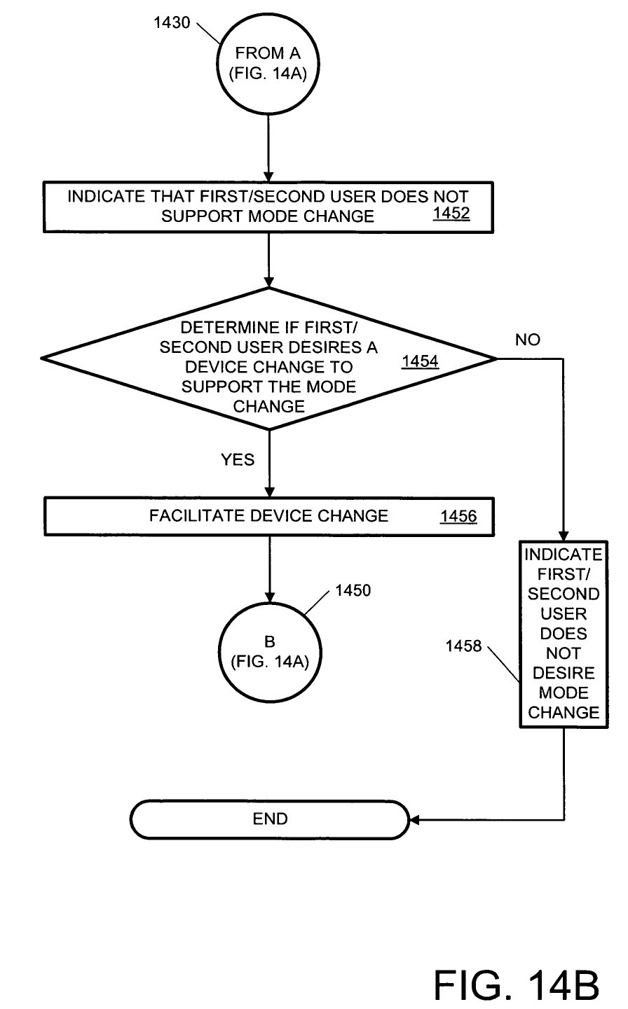

FIG. 14A is a flowchart diagram illustrating possible steps that may be taken when a communications network loses a communications session such as in the network from FIG. 4. The first step of this nonlimiting example is to facilitate a communications session (block 1432). Once the session is established, the next step is to begin storing session data (block 1434). Next, the network can receive a request for a mode change from the first user (block 1436). A mode change may include the first user determining that the present session may be better served if another functionality is implemented. As a nonlimiting example, a first user and a second user may begin a communications session that facilitates audio data communication. The first user, however, may determine that the communication would be more efficient if the session was communicating both audio data and video data. The first user (or the second user or both) may then request a mode change, which is received in block 1436.

Once the request is received, a determination can be made whether the first user's device supports the mode change requested (block 1438). This determination can be made by querying the first user's device for the requisite information, or accessing stored data regarding the capabilities of the first user's device. If it is determined that the first user's device does not support this device change, the flowchart directs the network to “go to” block 1430, which is illustrated in FIG. 14B.

FIG. 14B is a continuation flowchart diagram from FIG. 14A. FIG. 14B begins by indicating that the first user does not support the requested mode change (block 1452). Then a determination is made whether the first user desires to change devices in order to support the requested mode change (block 1454). If not, an indication of this fact may be provided (block 1458), and the flowchart ends (however the communications session may continue with no change in mode). However, if the first user desires to change devices to support the requested mode change, the device change is facilitated (1456), as described above. The flowchart then returns to FIG. 14A at block 1450.

Returning to block 1438, a determination is again made whether the first user's new device supports the requested mode change. If a mode change is supported, the next step is to request device capabilities regarding the second user's device (block 1440). Then, a determination can be made to determine whether the second user's device supports the requested mode change (block 1442). If the second user's device does not support the requested mode change, the flowchart will return to block 1430.

Returning to FIG. 14B, an indication can be provided that the second user's device does not support the requested mode change (block 1452). A determination can be made for a device change (block 1454). If a device change is not desired, an indication of this fact may be provided (block 1458), and the flowchart ends (although the communications session may or may not continue). However, if a device change is desired, the process facilitates the device change, as described above (block 1456), and the process then returns to FIG. 14A via block 1450.

On this return to FIG. 14A, the process again determines whether the second user's device supports the mode change (block 1442). Then a determination is made whether the second user desires the mode change (block 1444). While this step is illustrated as a separate determination, this may not necessarily be the case. In at least one embodiment, this determination can be coupled with the device change determination. The process may be able to reasonably infer that the second user desires the mode change if the second user changes devices to support the mode change. However, in at least one other embodiment, a query of the second user may be desired.

If the second user does not desire a mode change, an indication can be provided to the first user (block 1448), and the process can end. If however, the second user desires the mode change, the process can facilitate the change (block 1446). At this point the flowchart ends and the communications session can be resumed with the new mode functionality.

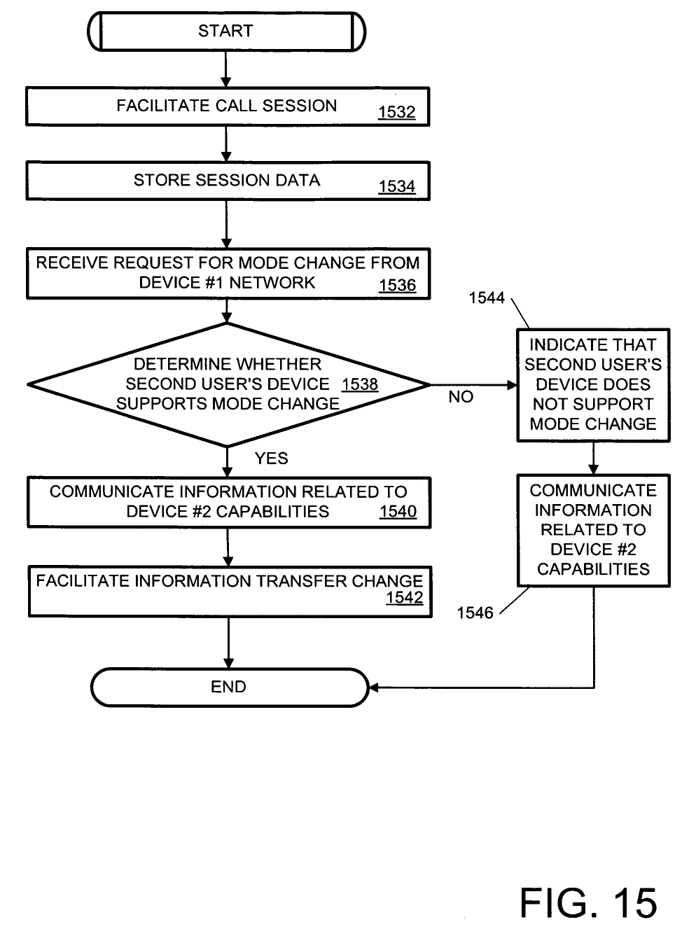

FIG. 15 is a flowchart diagram illustrating possible steps that may be taken when a communications network loses a communications session such as in the network from FIG. 4. While the nonlimiting example described with reference to FIG. 14A, 14B is directed to the first user's network, this nonlimiting example is directed to a similar process from the second user's perspective. As illustrated, the first step in this process is to facilitate a communications session (block 1532). Once the communications session is established, the process can begin storing session data (block 1534). The session can be stored incrementally, continuously, or in any manner to compile desired information. The process can then receive a request for a mode change from a network associated with the first user's device (block 1536).

Next, the process determines whether the second user's device supports the mode change (block 1538). This determination can occur by a network sending a query to the user device, without the knowledge of the user. Alternatively, a user query can occur, where the user is prompted for a voice or tone response (or both). If it is determined that the second user's device does not support the device change, the process can indicate this fact (block 1544) and communicate information related to the second user's device capabilities to the first user's network (block 1546). Alternatively, the user query can supplement information that was conveyed between the user device and the network via the Metadata. At this point the flowchart can end (although the communications session may or may not continue). If on the other hand, the second user's device supports the mode change, this information (along with other information) can be communicated to the first device's network (block 1540). At this point the process can facilitate the information transfer change (block 1542).

One should note that while the nonlimiting example listed above describes a process that facilitates a mode change, a mode change can also include a change of service providers. In at least one embodiment, the first user may desire that the current device is operating via a CMR network, however, an IPN is more desirable. Assuming that the device is equipped to communicate using the desired IPN protocol, such a mode change can be facilitated.

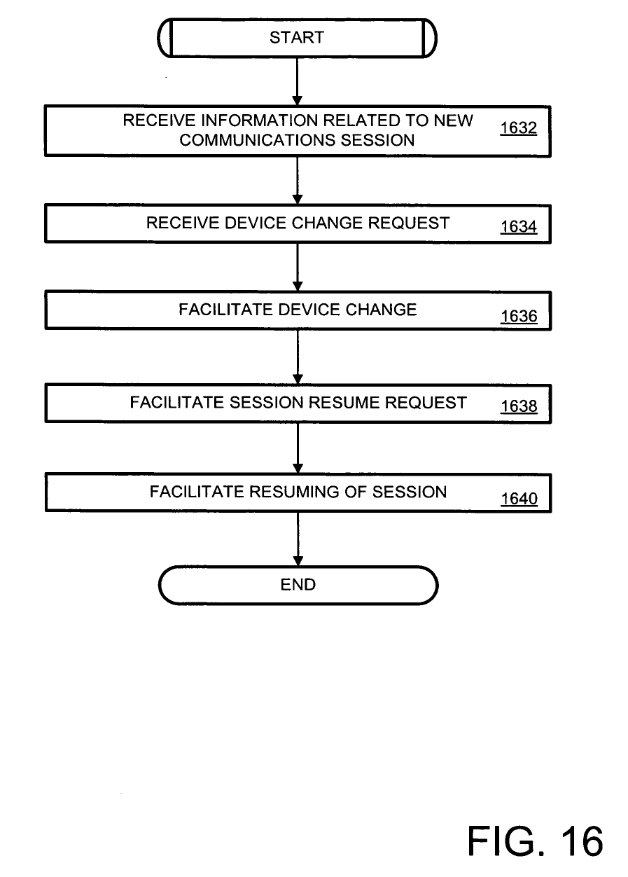

FIG. 16 is a flowchart diagram illustrating possible steps that may be taken when utilizing a session storage device such as the device from FIG. 6. While the previous nonlimiting examples discuss network configurations to facilitate various changes during a communications session, this nonlimiting example discusses various changes that can be made where various data is stored on a device. Such a scenario may occur as discussed with respect to FIG. 6, where data can be stored on a session storage device that may be inserted and removed from the user device to communicate session data.

The first step in the process of FIG. 16 is to receive information related to a new communications session (block 1632). When a communications session begins, the user device, a network associated with the user device, or both may communicate various information to the session storage device regarding the session, the device capabilities, and other information that may be relevant to the current session. The next step is to receive a device change request (block 1634). As discussed above, the device change request may occur as a result of a user pressing a button, or otherwise signifying such a change. Also, one should note that although the present disclosure omits a discussion of mode change with respect to a session storage device, such scenario is contemplated within this disclosure and would likely be similar to the description of FIG. 14A, 14B.

Next, the process can facilitate the device change (block 1636). This step can include a user simply removing the session storage device from the first user device and inserting it into the second user device. Alternatively, the session storage device may not be removable, but a communication between the first user device and the second user device can transfer the session information, thus facilitating the device change. Once the session information is present in the second user device, the session storage device may facilitate creating and communicating a session resume request (block 1638). After the session resume request is communicated, the session storage device may facilitate resuming the session with the second user device (block 1640).

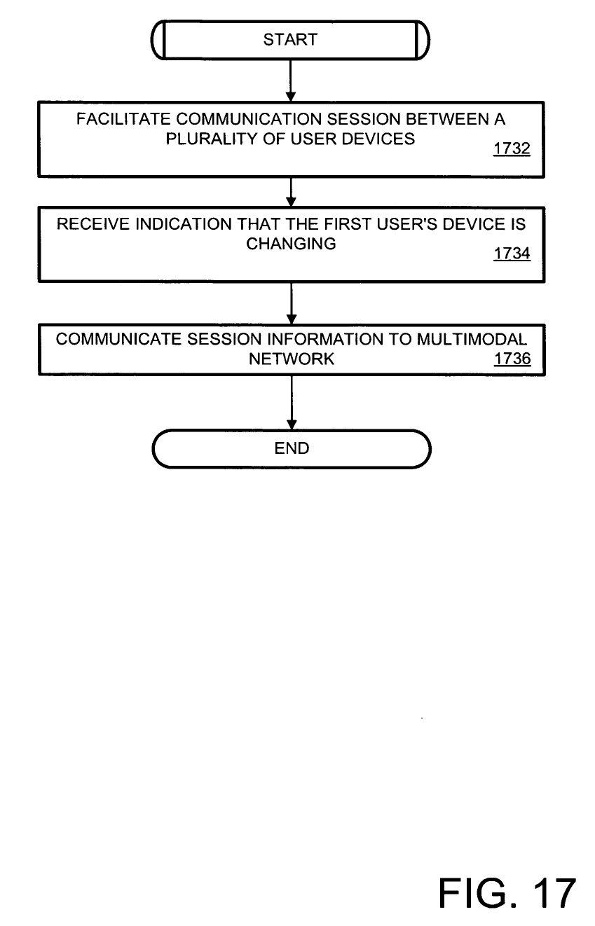

FIG. 17 is a flowchart diagram illustrating possible steps that may be taken when a communications network loses a communications session such as in the network from FIG. 5. In this nonlimiting example, a multimodal network may be coupled to the first user's device(s) and the second user's device(s), as illustrated in FIG. 5. The multimodal network may be configured to facilitate device or mode change or both.

One should note that the nonlimiting example of FIG. 17 is directed to a network associated with a first user's device. The first step in this nonlimiting example is to facilitate a communications session between a plurality of user devices (block 1732). While the communications networks discussed above in reference to FIGS. 1, 2, 4, and 5 may cooperatively create a communications session, the first user's communications network may be configured to retrieve device information related to at least one of the plurality of user devices involved in the communications session. Additionally, the first user's communications network also may be configured to retrieve other information including session length, user position, other devices the user may have access to, etc. This information can be compiled and stored in a network related to the first user's device or the information can be communicated to a multimodal network (or both).

Once a communications session is established, the first user's communications network can receive an indication that the first user's device is changing (block 1734). As discussed above, the first user may indicate a change of devices by any of a number of different actions, such as activating a signal on the first device, or simply using the second device. Once device change indication is received, the first user's network can communicate the compiled session information to the multimodal network (block 1736).

As discussed above, the session information may be compiled by the first user's communications network and upon a device change indication, the first user's communications network can communicate the compiled information to the multimodal network. As one of ordinary skill in the art will realize, this is but a nonlimiting example. In at least one embodiment the multimodal network compiles the session information and stores it periodically during the session. Alternatively, the session information may be compiled by the first user's communications network and periodically sent to the multimodal network, rather than only when a device change request is received.

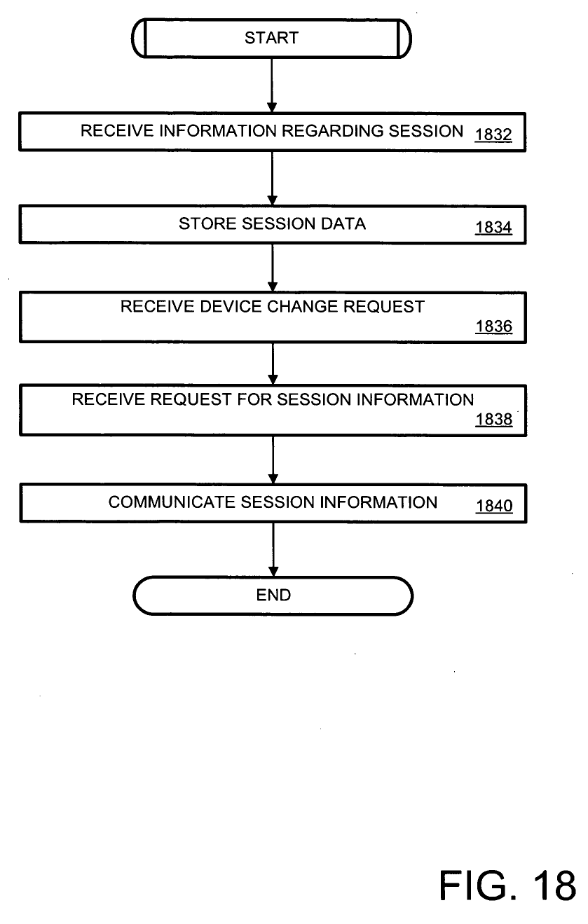

FIG. 18 is a flowchart diagram illustrating possible steps that may be taken in facilitating a device change in a network configuration, such as the configuration from FIG. 5. In this nonlimiting example, a multimodal network may first receive information related to a communications session (block 1832). The information may be received from a first user's device (or communications network) or a second user's device (or communications network) or both. Once the session information is received, the multimodal network may store the session data in a database (see FIG. 5) or other data storage device (block 1834).

Next, the multimodal network may receive an indication that the first user desires to change devices (block 1836). The multimodal network can then receive a request for session information (block 1838). The request may be communicated from the device or network of the user whose device is changing. Responsive to receiving a request for session information, the multimodal network can communicate session information to the requesting party (block 1840).

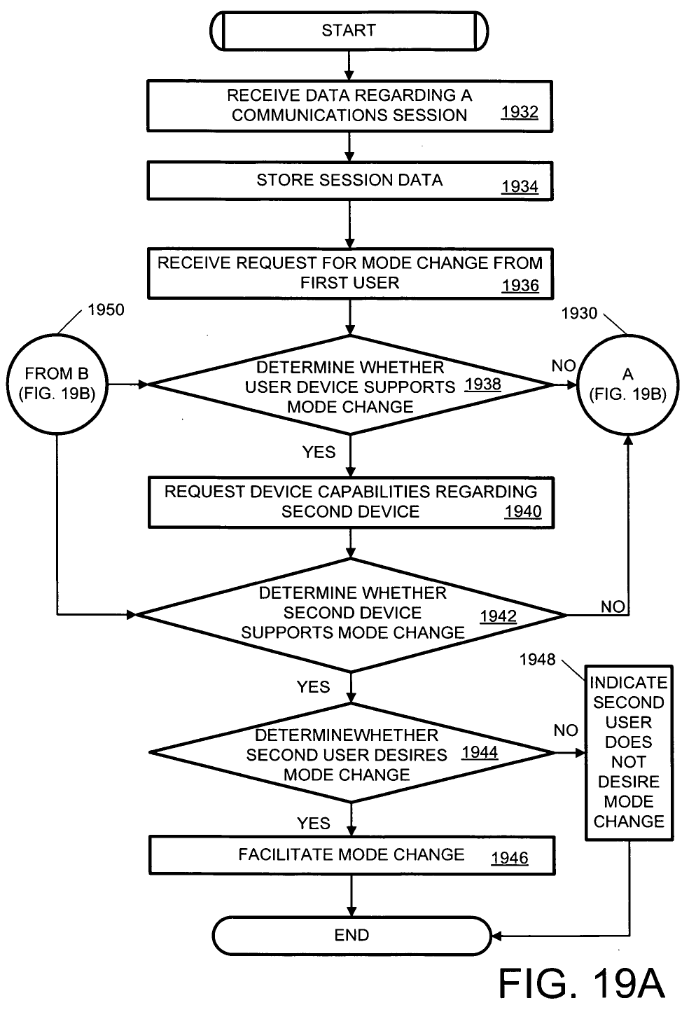

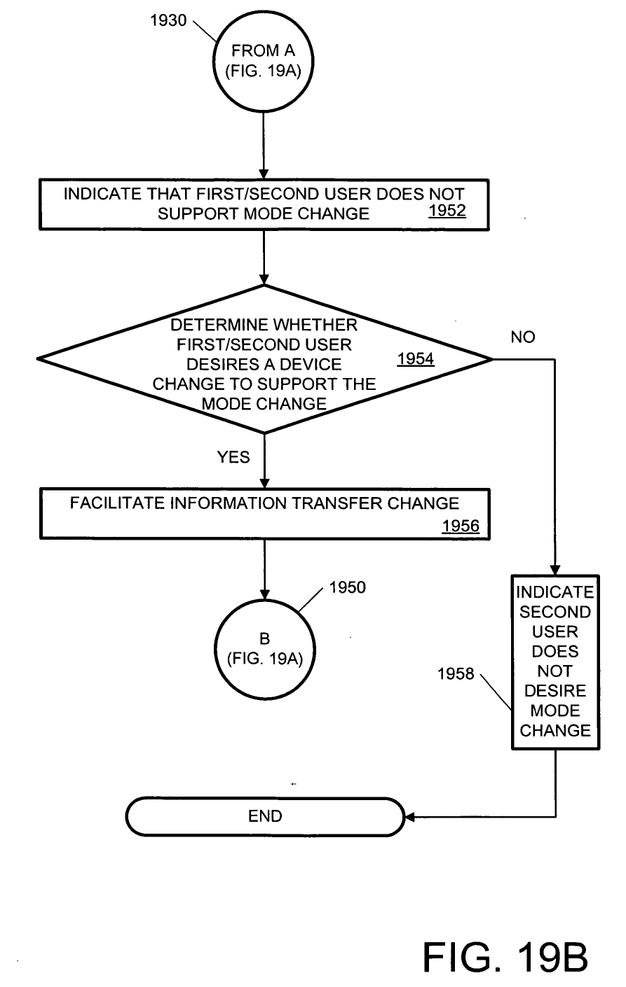

FIG. 19A is a flowchart diagram illustrating possible steps that may be taken in facilitating a mode change in a network configuration, such as the configuration from FIG. 5. The first step of this nonlimiting example is for the multimodal network to receive data regarding a communications session (block 1932). Once a communications session is established and data has been received, the multimodal network can store the session data in a database or other data storage device, as described above (block 1934). Then, the multimodal network can receive a request for a mode change from a first user (block 1936). A mode change may include a change from a first user device to a second user device, however, this is not a requirement.

In at least one nonlimiting example, a first user and a second user may be participating in a communications session, each using a personal computer that includes basic instant messaging (IM). The first user may decide that this communications session would be better served as an audio communication. The first user may still desire that the communications device remains the personal computer, but may desire to change to a voice over IP communications protocol. After a request is received, the multimodal network can determine whether the first user device supports the mode change (block 1938). If the first user's device does not support the requested mode change, block 1930 is taken to FIG. 19B.

FIG. 19B is a continuation flowchart diagram from FIG. 19A. The first step of the nonlimiting example from FIG. 19B is to indicate that the first user device does not support the requested mode change (block 1952). This indication may be communicated to the first user device requesting the mode change. Next, the multimodal server can determine whether the first user desires to change devices in order to accommodate the mode change (block 1954). If the user does not desire a device change, an indication of this fact may be provided (block 1958), the flowchart ends, and no mode change is realized. If, on the other hand, the user desires to change devices, the multimodal network can facilitate a device change (block 1956), as discussed above. At this point, the process advances to block 1950, which returns to FIG. 19A.

The multimodal network then can again determine if the new device supports the requested mode change (block 1938). If so, the multimodal network can request device capabilities regarding the second user's device (block 1940). Once this information is received, the multimodal network may determine whether the second user's device supports the requested mode change (block 1942). If the second user's device does not support the requested mode change, the process proceeds again to block 1930, which continues in FIG. 19B.

The next step is to indicate to the first user's device, the second user's device, or both that the second user's device does not support the requested mode change (block 1952). Next, the multimodal network can determine whether the second user desires a device change in order to support the requested mode change (block 1954).

If the second user does not desire a device change, an indication can be provided to the first user indicating this fact (block 1958), and the flowchart ends (although the communications session may or may not continue). If the second user does desire a device change, the multimodal network can facilitate the device change as described above (block 1956). The process then proceeds to block 1950, which returns to FIG. 19A.

At block 1950 the process proceeds and the multimodal network determines whether the second user's new device supports the requested mode change (block 1942). This determination can occur by the multimodal network communicating with the second user's new device, upon receiving the request for a mode change. Alternatively, the information can be stored in the network from a previous time, or if the second user's new device does support the requested mode change, the multimodal network can determine whether the second user desires the requested mode change (block 1944). As one or ordinary skill will realize, this step can be omitted in at least one embodiment when the second user has already changed devices as discussed with reference to FIG. 19B. In this scenario, the second user has implicitly indicated a desire to accept the mode change by changing devices in response to the requested mode change.

If the second user does not desire the requested mode change, an indication is provided to the first user (block 1948), and the flowchart ends. If on the other hand, the second user does desire the requested mode change, the multimodal network facilitates the mode change, as described above (block 1946). At this point the communications session may resume using the new mode capabilities (block 1946).

One should note that the flow charts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should also note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that many variations and modifications may be made to the above-described embodiments. All such modifications and variations are intended to be included herein within the scope of this disclosure and protected by the following claims.

Therefore, at least the following is claimed:

1. A method for communicating session information to a first communications device, the session information being related to a communications session that is established between a second communications device and a third communications device, the method comprising:
receiving session information related to the second communications device, wherein a set of active communications devices for the communications session includes the second communications device and the third communications device;
storing at least a portion of the session information related to the second communications device;
communicating at least a portion of the session information to the first communications device; and
resuming the communications session with the first device and the third device using at least a portion of the session information, wherein the set of active communications devices for the communications session has changed from the second communications device and the third communications device to the first communications device and the third communications device.

2. The method of claim 1, further comprising receiving session information related to the third communications device.

3. The method of claim 2, further comprising storing at least a portion of the session information related to the third communications device.

4. The method of claim 1, further comprising communicating with a first communications network, wherein the first communications network is configured to facilitate communication between the first communications device and another communications device.

5. The method of claim 4, further comprising communicating with a second communications network, wherein the second communications network is configured to facilitate communication between the second communications device and another communications device.

6. The method of claim 1, further comprising facilitating a communications session between the second communications device and the third communications device.

7. The method of claim 1, further comprising facilitating a mode change during the communications session, wherein the mode change includes at least one of the following: a device functionality change and a service provider change.

8. The method of claim 1, wherein at least a portion of the session information includes an Extensible Markup Language (XML) framework.

9. A method for maintaining session information while facilitating a mode change during a communications session between a first device and a second device, the method comprising:
receiving information related to the communications session;
receiving mode change request from the first device;
determining whether the second device supports the requested mode change;
receiving a communication from the second device requesting at least a portion of the information related to the session; and
facilitating the mode change while maintaining the communications session.

10. The method of claim 9, wherein at least a portion of the session information includes data in an Extensible Markup Language (XML) framework.

11. The method of claim 9, wherein the mode change includes at least one of the following: a device change, a device functionality change, and a service provider change.

12. The method of claim 9, wherein the session information includes at least one of the following: data related to the first device, data related to the second device, data related to the third device, data related to at least one service provider, and data related to session length.

13. The method of claim 9, further comprising determining whether the first communications device supports the mode change.

14. The method of claim 9, further comprising communicating a signal indicating that at least one of the user devices does not support the mode change.

15. A computer readable medium configured to facilitate a device change to a first device from a second device, while maintaining a communications session with a third device, the computer readable medium comprising:
logic configured to receive information related to the communications session, wherein the communications session is established between the second communications device and the third communications device;
logic configured to store at least a portion of the information related to the communications session;
logic configured to receive a communication from the second device requesting a device change to the first communications device;
logic configured to receive a communication from the first device requesting at least a portion of the information related to the session; and
logic configured to communicate at least a portion of the information related to the communications session to the first communications device, so that the first communications device can join the communications session in place of the second communications device.

16. The computer readable medium of claim 15, wherein at least a portion of the session information includes an Extensible Markup Language (XML) framework.

17. The computer readable medium of claim 15, further comprising logic configured to facilitate the communications session between the first device and the third device.

18. The computer readable medium of claim 15, wherein the session information includes at least one of the following: data related to the first device, data related to the second device, data related to the third device, data related to at least one service provider, and data related to session length.

19. The computer readable medium of claim 15, farther comprising logic configured to facilitate mediation regarding the information related to the communications session.

20. The computer readable medium of claim 15, further comprising logic configured to communicate session information with a network coupled to the first communications device and a network coupled to the second communications device via a common protocol.
